(19) United States
(12) Patent Application Publication
(10) Pub. No.: US 2024/0173850 A1
(43) Pub. Date: May 30, 2024

(54) ROBOTIC PAYLOAD FOR EXTRACTING AND DEPOSITING LIGHTWEIGHT MATERIALS

(71) Applicant: Signetron Inc., Berkeley, CA (US)

(72) Inventors: Emily Lathrop, San Diego, CA (US); Avideh Zakhor, Berkeley, CA (US)

(21) Appl. No.: 17/994,300

(22) Filed: Nov. 26, 2022

(51) Int. Cl. B25J 9/10; G05B 19/4155

(52) U.S. Cl. CPC B25J 9/1045; G05B 19/4155; G05B 2219/50391

(57) ABSTRACT

Robotic payloads for extracting and depositing lightweight materials are presented including: a length of self-supporting hose; three tendon drive assemblies coupled along an outside surface of the length of self-supporting hose, where the three tendon drive assemblies each include: a servo motor base; a servo motor coupled with the base, the servo motor having a tendon pulley; and a tendon coupled with the tendon pulley, the tendon pulley configured to wind in and wind out the tendon; a number of tendon guides secured to and along the length of self-supporting hose by a number of tendon bands such that the tendon runs freely along the length of self-supporting hose; and a tendon anchor positioned along an opening of the length of self-supporting hose for securing a distal end of the tendon.

### BACKGROUND

Air sealing an attic space is dirty, dangerous, tedious work currently performed by specialists. It is a task that is key to improving the energy efficiency of older homes by stopping the leakage of hot or cold air into the environment. In order to seal an attic, a necessary first step is to remove existing loose insulation to reveal gaps and seams in the panel insulation that lies underneath. Once insulation gaps are filled, the final step is to blow the loose insulation back into the attic. Insulation removal and reintroduction are tasks that are currently done by a human operator climbing into an attic with a large vacuum hose, carefully balancing on weight-bearing beams while vacuuming up loose insulation. Similarly, extracting and/or depositing materials in any confined, inaccessible, hazardous, or remote location may suffer similar constraints.

As such, robotic payloads for extracting and depositing lightweight materials are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, robotic payloads for extracting and depositing lightweight materials are presented including: a length of self-supporting hose; three tendon drive assemblies coupled along an outside surface of the length of self-supporting hose, where the three tendon drive assemblies each include: a servo motor base; a servo motor coupled with the base, the servo motor having a tendon pulley; and a tendon coupled with the tendon pulley, the tendon pulley configured to wind in and wind out the tendon; a number of tendon guides secured to and along the length of self-supporting hose by a number of tendon bands such that the tendon runs freely along the length of self-supporting hose; and a tendon anchor positioned along an opening of the length of self-supporting hose for securing a distal end of the tendon. In some embodiments, robotic payloads further include: a tendon pulley cover coupled with the servo motor base, the tendon pulley cover wrapping the tendon pulley to secure the tendon and having a tendon way to provide a passage for the tendon. In some embodiments, the lightweight materials include a density in a range of approximately 40-90 kg/m³. In some embodiments, robotic payloads further include the lightweight materials include a density in a range of approximately 12-130 kg/m³. In some embodiments, the lightweight materials include: fiberglass insulating material, a cellulose insulating material, a mineral wool insulating material, a polystyrene insulating material, a polyisocyanurate insulating material, a polyurethane insulating material, a perlite insulating material, a cementitious foam insulating material, a phenolic foam insulating material, a synthetic insulating material, and natural fiber insulating material. In some embodiments, the length of self-supporting hose includes: a flexible tube; and a wire support integral with the flexible tube. In some embodiments, the length of self-supporting hose includes a diameter in a range of approximately 150-500 mm. In some embodiments, the length of self-supporting hose includes a length in a range of approximately 3-20 meters. In some embodiments, the three tendon drive assemblies are positioned approximately 120° from each other around a circumference of the length of self-supporting hose.

In other embodiments, robotic extraction and deposition systems for extracting and depositing lightweight materials are presented including: a robot; a robotic payload carried by the robot, the robotic payload including: a length of self-supporting hose; three tendon drive assemblies coupled along an outside surface of the length of self-supporting hose, where the three tendon drive assemblies each include: a servo motor base; a servo motor coupled with the base, the servo motor having a tendon pulley; and a tendon coupled with the tendon pulley, the tendon pulley configured to wind in and wind out the tendon; a number of tendon guides secured to and along the length of self-supporting hose by a number of tendon bands such that the tendon runs freely along the length of self-supporting hose; and a tendon anchor positioned along an opening of the length of self-supporting hose for securing a distal end of the tendon.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative representation of a robotic payload in accordance with embodiments of the present invention;

FIG. 2 is an illustrative front view representation of a self-supporting hose for a robotic payload in accordance with embodiments of the present invention;

FIG. 3 is an illustrative representation of a control system for a robotic payload in accordance with embodiments of the present invention;

FIG. 4 is an illustrative representation of robot for use with a robotic payload in accordance with embodiments of the present invention; and

FIG. 5 is an illustrative representation of robot for use with a robotic payload in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

As will be appreciated by one skilled in the art, the present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals /per se/, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In still other instances, specific numeric references such as “first material,” may be made. However, the specific numeric reference should not be interpreted as a literal sequential order but rather interpreted that the “first material” is different than a “second material.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately.” or “substantially” for any numerical values or ranges indicate a suitable dimensional tolerance that allows the part or collection of components to function for its intended purpose as described herein.

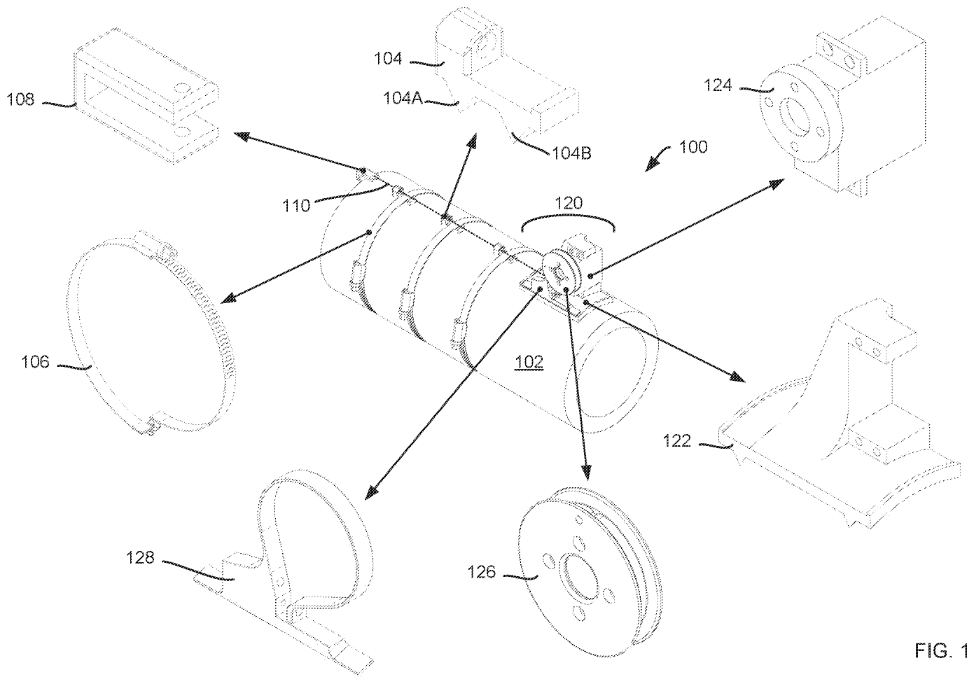

FIG. 1 is an illustrative representation of a robotic payload 100 in accordance with embodiments of the present invention. As illustrated, robotic payload 100 includes a length of self-supporting hose 102. In conventional solutions, robotically controlled hoses typically require an external support or scaffolding system. These solutions are limited in both the type of material that may be transported across the hose as well as in the movement envelope that defines the range of motion of the hose. Present embodiments allow for extraction (in-flow) and deposition (out-flow) of lightweight materials within an expanded range of motion. Further, a self-supporting hose simplifies operation and control of embodiments disclosed herein. In embodiments, self-supporting hoses include a flexible tube and a wire support integral with the flexible tube. This arrangement provides general structural support for the flexible tube as well as the ability for the flexible tube to be compressed and expanded easily. In embodiments, self-supporting hoses have a diameter in a range of approximately 150-500 mm and a length in a range of approximately 3 to 20 meters. Notably, embodiments disclosed herein may be utilized for both extracting and depositing lightweight materials. For example, embodiments may be utilized to remove loose or friable materials. In some embodiments, the lightweight materials may include without limitation: fiberglass insulating materials, cellulose insulating materials, mineral wool insulating materials, polystyrene insulating materials, polyisocyanurate insulating materials, polyurethane insulating materials, perlite insulating materials, cementitious foam insulating materials, phenolic foam insulating materials, synthetic insulating materials, and natural fiber insulating material. In some embodiments, the lightweight materials have a density in a range of approximately 40-90 kg/m³. In other embodiments, the lightweight materials have a density in a range of approximately 12-130 kg/m³. In operation, robotic payload embodiments may be coupled with a vacuum system for extracting lightweight materials and with a delivery system for depositing lightweight materials.

Further illustrated are a number of tendon guides 104 secured to and along self-supporting hose 102 by tendon bands 106. Tendon guides may be manufactured from any suitable metallic, semi-metallic, synthetic, or semi-synthetic material known in the art without departing from embodiments disclosed herein. In one embodiment, tendon guides may be 3D printed. As shown, tendon guides 104 capture tendon 110 and allow the tendon to freely move along the length of self-supporting hose. Self-supporting hose movement is achieved by retracting and extending the tendons individually. As illustrated, tendon guide 104 includes tendon guide legs 104A and 104B that are sized to accommodate any pleats on a self-supporting hose. Pleats allow for expansion and contraction of the self-supporting hose. Further illustrated are tendon bands 106 that mechanically secure the tendon guide to the self-supporting hose. The number of tendon guides and tendon bands depend on the length of the self-supporting hose. In some embodiments, tendon guides are spaced along the self-supporting hose in a range of approximately 75-300 mm. In embodiments, robotic payload 100 further includes tendon anchor 108 positioned along an opening of the length of self-supporting hose for securing a distal end of the tendon. Tendon anchors may be manufactured from any suitable metallic, semi-metallic, synthetic, or semi-synthetic material known in the art without departing from embodiments disclosed herein. In one embodiment, tendon anchors may be 3D printed.

Further illustrated is tendon drive assembly 120. Although only one tendon drive assembly is shown for clarity, however, in embodiments, three tendon drive assemblies are utilized and positioned approximately 120 degrees from each other around the circumference of the self-supporting hose. As shown, tendon drive assembly 120 includes servo motor base 122 that is coupled with servo motor 124 and utilized to secure the servo motor to the self-supporting hose. In addition, servo motor 124 includes tendon pulley 126 upon which tendon 110 is wound in (retracted) and wound out (extended). In order to retain the tendon, in the embodiment illustrated, tendon pulley cover 128 is coupled with servo motor base 122. In embodiments, tendon pully cover wraps the tendon pully and includes a tendon way to provide a passage for the tendon. As above, servo motor bases, tendon pulleys, and tendon pulley covers may be manufactured from any suitable metallic, semi-metallic, synthetic, or semi-synthetic material known in the art without departing from embodiments disclosed herein. In one embodiment, servo motor bases, tendon pulleys, and tendon pulley covers may be 3D printed.

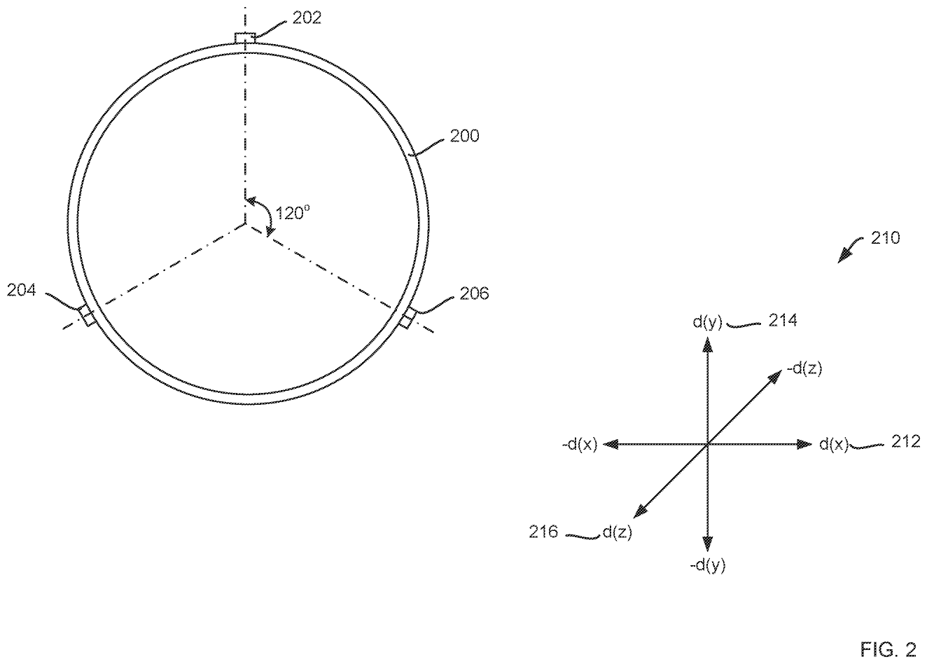

FIG. 2 is an illustrative front view representation of a self-supporting hose 200 for a robotic payload in accordance with embodiments of the present invention. As illustrated, three tendon anchors 202, 204, and 206 are positioned approximately 120 degrees from each other around the circumference of self-supporting hose 200. In embodiments, the arrangement of the tendon drive assemblies and associated tendon elements along the self-supporting hose support three axes of movement as shown by 210. That is, robotic payload embodiments enable three types of hose (or trunk) motion: in and out in a telescoping manner d(z) 216, end effector (hose tip) movement up and down d(y) 214, and end effector movement left and right d(x) 212.

In embodiments, tendon lengths L₁, L₂, L₃ are modified by servos S₁, S₂, S₃ each corresponding with a different tendon drive assembly. Each servo is configured to rotate a total of five rotations and achieve angles from 0 to 2*PI*5 radians. The lengths of the tendons are:

L₁=theta S₁*4 cm/(2*PI radians)+L_{fixed} where L_{fixed} is the measured length of the tendon when the hose is fully retracted.

L₂=theta S₂*4 cm/(2*PI)+L_{fixed}

L₃=theta S₃*4 cm/(2*PI)+L_{fixed}

The incremental left/right movement of the self-supporting hose (delta Ln) is controlled by an x joystick direction where:

delta L₂=−d(x)

delta L₃=+d(x)(differential movement).

The self-supporting hose up/down movement is controlled by a y joystick direction where:

delta L₁=−d(y)

delta L₂=−d(y)/4*

delta L₃=−d(y)/4*
As the top tendon is raised, the side tendons are retracted by ¼ the amount to maintain tension in the tendons.

The self-supporting hose in/out movement is controlled a z joystick direction where all three tendons are moved together:

deltaL₁=d(z)

deltaL₂=d(z)

deltaL₃=d(z)

In an embodiment, a user operates a radio controller to control movement of the self-supporting hose via three tendons running down the length of the self-supporting hose. The right joystick left/right movement controls the vacuum left and right movement. Pushing the joystick to the right shortens the left tendon by x amount and lengthens the right tendon by x amount, where x is determined by the amount you push the joystick to either side. That is, tendons move differentially—one retracts as the other extends. Right joystick up and down raises and lowers the self-supporting hose, retracting the top tendon to raise the self-supporting hose, and pulling in the side tendons by ¼ the amount to keep tendon tension. Left joystick up and down can be inverted on a transmitter, so stick down (default) reads high, stick up reads low. High means tendons are fully extended, low means fully retracted. This joystick extends and retracts the self-supporting hose by moving all three servos equally by a distance proportional to the amount the user pulls the trigger.

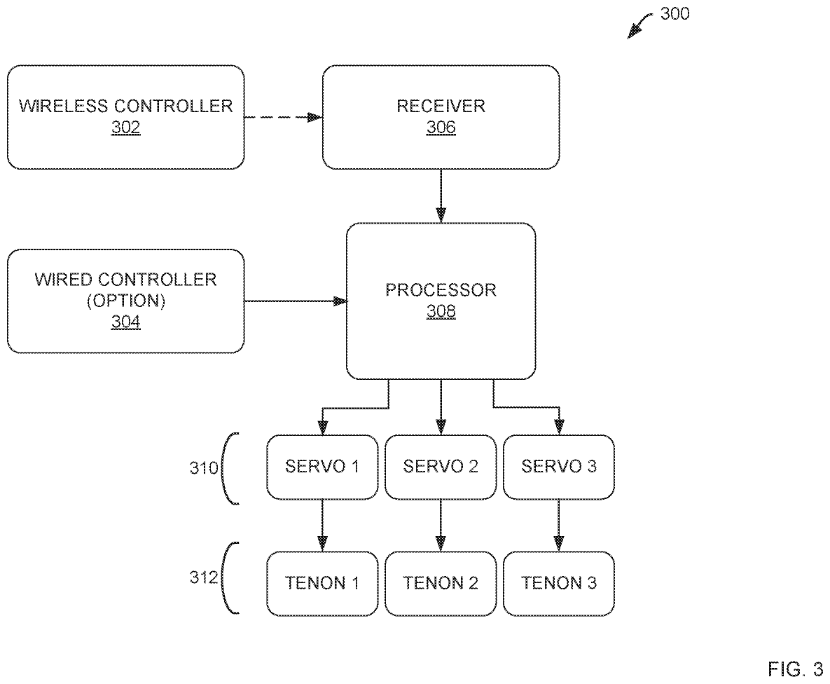

FIG. 3 is an illustrative representation of a control system 300 for a robotic payload in accordance with embodiments of the present invention. Notably, embodiments disclosed herein contemplate both wireless controllers 302 and wired controllers 304. In the former instances, received 306 is required to received wireless commands. In some embodiments, a six-channel remote control transmitter may be utilized. Commands received either wirelessly or wired are received at processor or microcontroller 308, which sends movement information to servos 310 that extend or retract tendons 312. In an embodiment, all the above may be powered with 6V power that comes from a 12V to 6V DC power converter, which is also located on the robot. The input voltage for this power converter may be chosen to be equal to the battery operating voltage of a tracked robot upon which is placed a robotic payload embodiment. This arrangement can be generalized by specifying a DC converter that can interface with any robotic body and take as an input whatever voltage the robot is being powered from. The DC converter will then step that voltage down to 6V to power the payload. Video captured by a camera mounted with the robotic payload or robot may be utilized to guide and steer the robot thus enhancing remote operation.

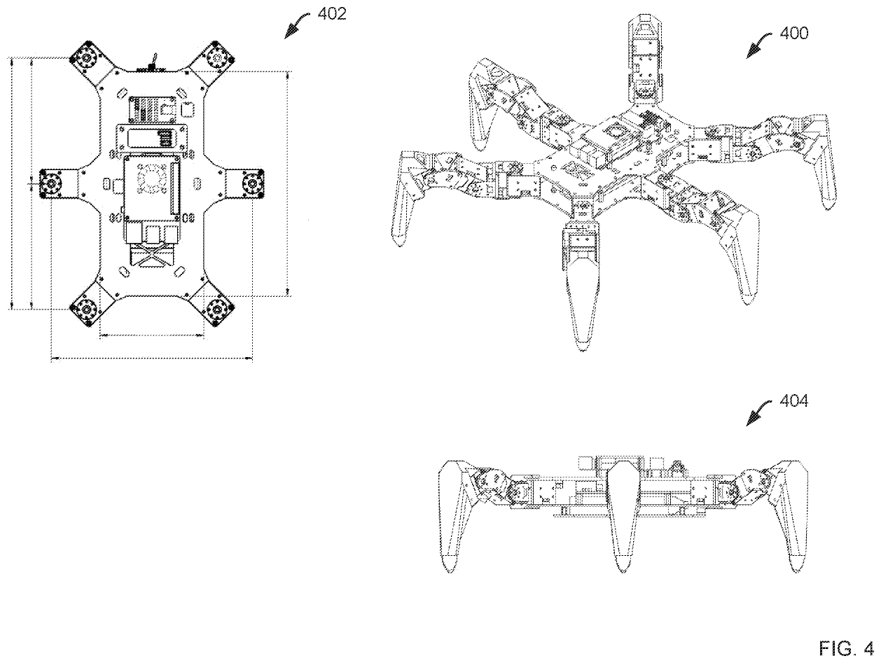

FIG. 4 is an illustrative representation of robot 400, 402, and 404 for use with a robotic payload in accordance with embodiments of the present invention. As may be appreciated, any type of suitable robot may be utilized to carry robotic payloads disclosed herein. As illustrated, a hexapod robot having multiple articulating legs may be particularly useful in navigating areas having floor level obstacles. In one example a hexapod robot may be utilized to navigate attic joists or other similarly confined spaces.

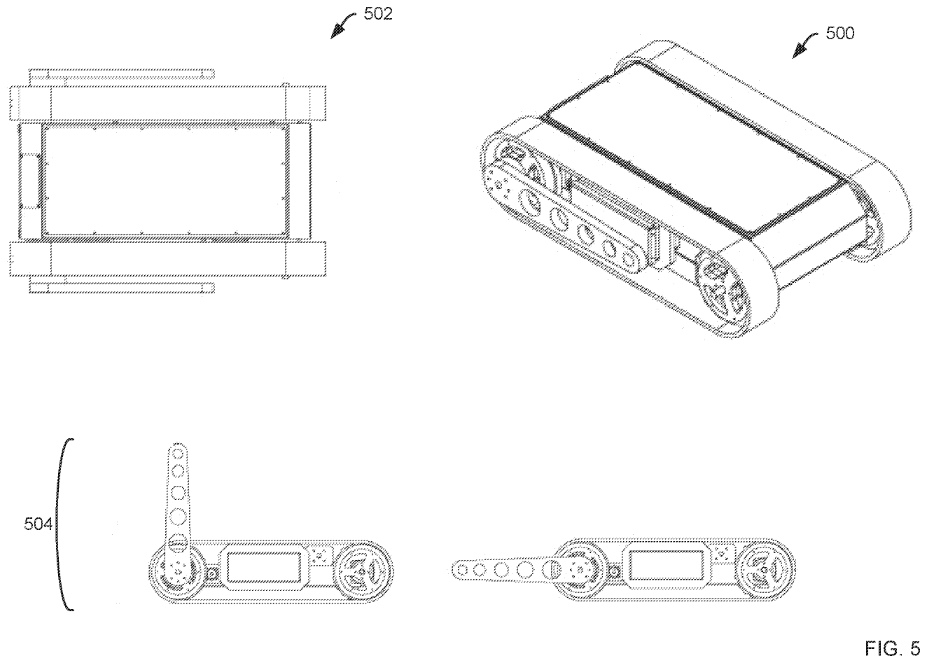

FIG. 5 is an illustrative representation of robot 500, 502, and 504 for use with a robotic payload in accordance with embodiments of the present invention. As may be appreciated, any type of suitable robot may be utilized to carry robotic payloads disclosed herein. As illustrated, a tracked robot having two rotating legs may be particularly useful in navigating areas having floor level obstacles. In one example a tracked robot may be utilized to navigate attic joists or other similarly confined spaces.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A robotic payload for extracting and depositing lightweight materials comprising:
a length of self-supporting hose;
three tendon drive assemblies coupled along an outside surface of the length of self-supporting hose, wherein the three tendon drive assemblies each comprise:
a servo motor base;
a servo motor coupled with the base, the servo motor having a tendon pulley; and
a tendon coupled with the tendon pulley, the tendon pulley configured to wind in and wind out the tendon;
a plurality of tendon guides secured to and along the length of self-supporting hose by a plurality of tendon bands such that the tendon runs freely along the length of self-supporting hose; and
a tendon anchor positioned along an opening of the length of self-supporting hose for securing a distal end of the tendon.

2. The robotic payload of claim 1, further comprising:
a tendon pulley cover coupled with the servo motor base, the tendon pulley cover wrapping the tendon pulley to secure the tendon and having a tendon way to provide a passage for the tendon.

3. The robotic payload of claim 1, wherein the lightweight materials comprise a density in a range of approximately 40-90 kg/m³.

4. The robotic payload of claim 1, wherein the lightweight materials comprise a density in a range of approximately 12-130 kg/m³.

5. The robotic payload of claim 1, wherein the lightweight materials are selected from the group consisting of: fiberglass insulating material, a cellulose insulating material, a mineral wool insulating material, a polystyrene insulating material, a polyisocyanurate insulating material, a polyurethane insulating material, a perlite insulating material, a cementitious foam insulating material, a phenolic foam insulating material, a synthetic insulating material, and natural fiber insulating material.

6. The robotic payload of claim 1, wherein the length of self-supporting hose comprises:
a flexible tube; and
a wire support integral with the flexible tube.

7. The robotic payload of claim 1, wherein the length of self-supporting hose comprises a diameter in a range of approximately 150-500 mm.

8. The robotic payload of claim 1, wherein the length of self-supporting hose comprises a length in a range of approximately 3-20 meters.

9. The robotic payload of claim 1, wherein the three tendon drive assemblies are positioned approximately 120° from each other around a circumference of the length of self-supporting hose.

10. A robotic extraction and deposition system for extracting and depositing lightweight materials comprising:
a robot;
a robotic payload carried by the robot, the robotic payload comprising:
a length of self-supporting hose;
three tendon drive assemblies coupled along an outside surface of the length of self-supporting hose, wherein the three tendon drive assemblies each comprise:
a servo motor base;
a servo motor coupled with the base, the servo motor having a tendon pulley; and
a tendon coupled with the tendon pulley, the tendon pulley configured to wind in and wind out the tendon;
a plurality of tendon guides secured to and along the length of self-supporting hose by a plurality of tendon bands such that the tendon runs freely along the length of self-supporting hose; and
a tendon anchor positioned along an opening of the length of self-supporting hose for securing a distal end of the tendon.

11. The system of claim 10, further comprising:
a tendon pulley cover coupled with the servo motor base, the tendon pulley cover wrapping the tendon pulley to secure the tendon and having a tendon way to provide a passage for the tendon.

12. The system of claim 10, wherein the lightweight materials comprise a density in a range of approximately 40-90 kg/m³.

13. The system of claim 10, wherein the lightweight materials comprise a density in a range of approximately 12-130 kg/m³.

14. The system of claim 10, wherein the lightweight materials are selected from the group consisting of: fiberglass insulating material, a cellulose insulating material, a mineral wool insulating material, a polystyrene insulating material, a polyisocyanurate insulating material, a polyurethane insulating material, a perlite insulating material, a cementitious foam insulating material, a phenolic foam insulating material, a synthetic insulating material, and a natural fiber insulating material.

15. The system of claim 10, wherein the length of self-supporting hose comprises:
a flexible tube; and
a wire support integral with the flexible tube.

16. The system of claim 10, wherein the length of self-supporting hose comprises a diameter in a range of approximately 150-500 mm.

17. The system of claim 10, wherein the length of self-supporting hose comprises a length in a range of approximately 3-20 meters.

18. The system of claim 10, wherein the three tendon drive assemblies are positioned approximately 120° from each other around a circumference of the length of self-supporting hose.

19. The system of claim 10, wherein the robot is selected from the group consisting of: a hexapod robot and a tracked robot.
